(19) United States
(12) Patent Application Publication
(10) Pub. No.: US 2001/0031792 A1
(43) Pub. Date: Oct. 18, 2001

(54) Process for preparing polyorganosiloxane emulsions

(76) Inventors: Stefan Silber, Krefeld (DE); Roland Sucker, Werne (DE)

Correspondence Address: William F. Lawrence, Esq., c/o FROMMER LAWRENCE & HAUG LLP, 745 Fifth Avenue, New York, NY, 10151, US

(21) Appl. No.: 09/799,256

(22) Filed: Mar. 5, 2001

(30) Foreign Application Priority Data
Mar. 9, 2000 (DE) 100 11 564.0

(51) Int. Cl. C09K 3/00

(52) U.S. Cl. 516/104

(57) ABSTRACT

The invention relates to a process for preparing polyorganosiloxane emulsions whose internal phase comprises the active polyorganosiloxane substance and whose external phase comprises, in solution or dispersion, an emulsifier or an emulsifier mixture and, if desired, an emulsion-stabilizing protective colloid, to the polysiloxane emulsions thus obtainable and, in particular, to the use of these macroemulsions, so prepared, as defoamers.

### RELATED APPLICATIONS

This application claims priority to German application No. 100 11 564.0, filed Mar. 9, 2000.

### BACKGROUND OF THE INVENTION

1. Field of the Invention

The invention relates to a process for preparing polyorganosiloxane emulsions whose internal phase comprises the active polyorganosiloxane substance and whose external phase comprises, in solution or dispersion, an emulsifier or an emulsifier mixture and, if desired, an emulsion-stabilizing protective colloid, to the polysiloxane emulsion thus obtainable and, in particular, to the use of these macroemulsions, so prepared, as defoamers.

2. Description of the Related Art

Known defoamer emulsions are, in accordance with the prior art (DE 28 29 906 A, DE 42 37 754 A), macroemulsions whose dispersed phase comprises particles having average sizes of up to 100 μm. The internal phase consists of the active defoamer substance or comprises it in a carrier medium such as, for example, a solvent.

The use of polyorganosiloxanes, in the form for example of silicone oils or polyethersiloxane copolymers, as defoamer oils is known (U.S. Pat. No. 3,763,021 and U.S. Pat. No. 5,804,099, herein incorporated be reference). The oils may comprise finely divided solids which reinforce the defoaming action. An example of a suitable finely divided solid of this kind is highly disperse, usually pyrolytically obtained silica, which may have been hydrophobicized by treatment with organosilicon compounds (R. E. Patterson, Coll. And Surfaces A, 74, 115 (1993) herein incorporated by reference).

The use of these polyorganosiloxanes is preferred in particular in the form of their o/w emulsions, since depending on the chosen stirring and homogenizing mechanism it is possible to carry out initial adjustment of the size of the defoamer oil droplets. If the input of shearing force into the system to be defoamed is low, this distribution can be transferred. The respective particle size distribution is critical to the characteristics of the defoamer in the system to be defoamed. In view of the meterability as well, the use of o/w emulsions is greatly preferred over the active substances alone.

However, the preparation of such o/w emulsions in many cases necessitates complex multistage processes; in particular, resulting product qualities of these macroemulsions are frequently inadequate.

For example, owing to their relatively large particles in the disperse phase, such polyorganosiloxane emulsions tend toward sedimentation and coalescence. As a result, in particular, the profiles of properties (activity, tendency toward surface defects) of such defoamer emulsions are fluctuating and variable over time, leading again and again to problems in use. Although this effect can be countered by increasing the viscosity using protective colloids, the achievable thermal stabilities and shaking stabilities are still inadequate in many cases. Moreover, there has been no lack of attempts to improve these properties by means of higher emulsifier contents. The skilled worker is well aware, however, that the activity of defoamers decreases drastically over time as the emulsifier content goes up.

A dispersing process based on the serial connection of product mixtures has hitherto been described for the preparation of inkjet printer inks (U.S. Pat. No. 5,168,022 or U.S. Pat. No. 5,026,427) or magnetic powder dispersions (U.S. Pat. No. 5,927,852).

A similar principle is known (U.S. Pat. No. 4,908,154, herein incorporated by reference) for the preparation of microemulsions (all droplets <1 μm). In this case, however, the product stream is divided into two parts, changes its direction, collides with itself in a countercurrent process, and then flows back together into one stream.

The preparation of polyorganosiloxane emulsions by means of this process is unknown.

### SUMMARY OF THE INVENTION

It is an object of the present invention, therefore, to prepare polyorganosiloxane emulsions which are more stable with respect to coalescence and sedimentation on exposure to heat and shaking, have a lower emulsifier content, possess good defoaming properties, and retain this performance for a prolonged period.

An object on which the invention is based is surprisingly achieved by using the following process for preparing the polyorganosiloxane emulsions:

a) formulating a mixture from:

from about 5 to about 50% by weight of polyorganosiloxanes optionally comprising hydrophobic solid bodies,

from 0 to about 20% by weight of organic oil,

from about 0.5 to about 10% by weight of one or more nonionic or anionic emulsifiers,

from about 40 to about 95% by weight of water, and

if desired, thickeners, protective colloids and/or auxiliary preservatives;

b) passing this mixture through, and dispersing it in, at least one interaction chamber having a capillary thickness of from about 100 to about 500 μm in a pressure range from about 100 to about 1000 bar; and

c) releasing this mixture in an outlet reservoir,

the average droplet sizes being from about 0.5 to about 100 μm.

### DETAILED DESCRIPTION OF THE INVENTION

Surprisingly, the emulsion stabilities of O/W polyorganosiloxane emulsions prepared in accordance with the invention are significantly improved in comparison to emulsions prepared by conventional methods (high-pressure homogenizer, rotor/stator systems, colloid mill, etc.) or, respectively, it is possible to prepare emulsions having a much smaller emulsifier requirement and, accordingly, an improved profile of properties. The formulation comprising polyorganosiloxane, emulsifier(s), water and, if desired, further additives is passed under a pressure of from about 100 to about 1000 bar, preferably from about 100 to about 600 bar, with particular preference from about 150 to about 450 bar, through one or more microchannels having capillary thicknesses of from about 100 to about 500 μm, ideally from about 200 to about 400 μm. A preferred feature of these capillary microchannels is that at least at one point they are angled, so that the product stream is diverted in its direction. Following release and collection of the polyorganosiloxane emulsion, a product is obtained which features average droplet sizes of from about 0.5 to about 100 μm.

The advantageous suitability of the process of the invention for preparing these macrodisperse polyorganosiloxane emulsions is, therefore, highly surprising.

Polyorganosiloxane emulsions of this kind may not only be used as defoamers but are also suitable as release agents or architectural preservatives, such as waterproofing agents.

The defoamer emulsions for preparation in accordance with the invention may be used in a conventional manner, inter alia, for defoaming surfactant solutions, surfactant concentrates, latices, all-acrylate dispersions (for papercoatings, adhesives and emulsion paints, for example), coating materials, and aqueous printing inks.

As emulsifiers, the polyorganosiloxane emulsions prepared by the process of the invention and intended for use in accordance with the invention comprise one or more nonionic or anionic emulsifiers. Examples of nonionic emulsifiers are the fatty acid esters of polyhydric alcohols, their polyalkylene glycol derivatives, the polyglycol derivatives of fatty acids and fatty alcohols, alkylphenol ethoxylates, and also block copolymers of ethylene oxide and propylene oxide, ethoxylated amines, amine oxides, acetylenediol surfactants, and silicone surfactants. It is preferred to use ethoxylation derivatives of fatty chemical raw materials. Particular preference is given to nonionic oleyl and stearyl derivatives.

Examples of anionic emulsifiers are dialkylsulfosuccinates (Emcol® 4500), alkyl ether sulfates and alkyl ether phosphates, alkyl sulfates (Witcolate® D5-10) and alpha-olefinsulfonates (Witconate® AOS). Mention may also be made of specific block copolymer emulsifiers, as described in DE 198 36 253 A, herein incorporated by reference.

Exemplary protective colloids and thickeners are cellulose derivatives such as methylcellulose, carboxymethylcellulose, hydroxyethylcellulose, hydroxypropyl-cellulose, and also synthetic polymers such as polyvinyl alcohol, polyacrylates and maleic anhydride copolymers (U.S. Pat. No. 4,499,233, U.S. Pat. No. 5,023,309) or, for example, in particular linear and branched polyurethanes (U.S. Pat. No. 4,079,028, U.S. Pat. No. 4,155,892), polyureas, polyetherpolyols (U.S. Pat. No. 4,288,639, U.S. Pat. No. 4,354,956, U.S. Pat. No. 4,904,466) and also biosynthetic polymers such as xanthan gum, all herein incorporated by reference.

Examples of inorganic solids are unhydrophobicized or hydrophobicized silica, alumina, alkaline earth metal carbonates or similar finely divided solids which are customary and known from the prior art. As finely divided organic substances it is possible to use alkaline earth metal salts of long-chain fatty acids of 12 to 22 carbon atoms that are known for this purpose, the amides of these fatty acids, and also polyureas.

Polyorganosiloxane emulsions for preparation in accordance with the invention are described by way of example in the working examples. In said examples, the material formulations correspond to the prior art as described, for example, in DE 24 43 853 A, DE 38 07 247 A, and DE 42 37 754 A, herein incorporated by reference.

### WORKING EXAMPLES

### Example 1

5 parts of a mixture of equal parts of ethoxylated triglyceride (Atlas® G1300 from ICI) and ethoxylated fatty acid (Brij® 72 from ICI) were added to 74.55 parts of water at 60° C. 0.25 part of an anionic polyacrylamide (Praestol® from Stockhausen) was then scattered into this hot mixture. The mixture was stirred for 10 minutes and 20 parts of an SiO₂ (5 parts of Sipemat® D10 from Degussa)-containing organosiloxane (Tego® Glide B 1484 from Tego) which had a viscosity of 800 mPas and an average molecular mass of 8500 g/mol were added. After stirring for a further 10 minutes, the mixture was pumped at 300 bar through two interaction chambers connected in series, the capillary thickness of the first chamber being 400 μm and that of the second chamber being 200 μm. At the outlet, the mixture was cooled to <30° C. by means of a plate cooler. An emulsion was formed which showed no deposition in either neat or diluted form.

### Example 2

5 parts of a mixture of equal parts of ethoxylated triglyceride as in Example 1 and ethoxylated fatty acid as in Example 1 were added to 73.29 parts of water at 60° C. 0.16 part of the polyacrylamide as in Example 1 and 1.35 parts of a linear, water-dispersible polyurethane (Coatex® BR 910 from Coatex) were then scattered into this hot mixture. The mixture was stirred for 10 minutes and 16.00 parts of the SiO₂-containing organosiloxane as in Example 1 and 4.00 parts of a polyalkylene glycol ether (Arcol® 2000N from Lyondell) having a MW of approximately 2000 g/mol were added. After stirring for a further 10 minutes, the mixture was pumped at 150 bar through an interaction chamber whose capillary thickness was 400 μm. At the outlet, the mixture was cooled to <30° C. by means of a plate cooler. An emulsion was formed which showed no deposition in either neat or diluted form.

### Example 3

5 parts of a mixture of equal parts of ethoxylated triglyceride as in Example 1 and ethoxylated fatty acid as in Example 1 were added to 74.55 parts of water at 70° C. 0.25 part of the polyacrylamide as in Example 1 was then scattered into this hot mixture. The mixture was stirred for 10 minutes and 20 parts of an SiO₂ (5 parts of Sipemat® D10 from Degussa)-containing organosiloxane (Tego® Antifoam EH 7284-6 from Goldschmidt) which had a viscosity of 1600 mPas and an average molecular mass of 12000 g/mol were added. After stirring for a further 10 minutes, the mixture was pumped at 250 bar through two interaction chambers connected in series, the capillary thickness of the first chamber being 400 μm and that of the second chamber being 200 μm. At the outlet, the mixture was cooled to <30° C. by means of a plate cooler. An emulsion was formed which showed no deposition in either neat or diluted form.

### Example 4

3 parts of a mixture of equal parts of ethoxylated triglyceride as in Example 1 and ethoxylated fatty acid as in Example 1 were added to 74.55 parts of water at 70° C. 0.25 part of the polyacrylamide as in Example 1 was then scattered into this hot mixture. The mixture was stirred for 10 minutes and 20 parts of an SiO₂-containing organosiloxane as in Example 3 were added. After stirring for a further 10 minutes, the mixture was pumped at 150 bar through two interaction chambers connected in series, the capillary thickness of the first chamber being 400 μm and that of the second chamber being 200 μm. At the outlet, the mixture was cooled to <30° C. by means of a plate cooler. An emulsion was formed which showed no deposition in either neat or diluted form.

### Comparative Example 1

5.00 parts of a mixture of equal parts of ethoxylated triglyceride as in Example 1 and ethoxylated fatty acid as in Example 1 were added to 10.00 parts of water at 60° C. and the mixture was stirred for 10 minutes with a turbine at a peripheral speed of 6 m/s. 20 parts of the SiO₂-containing organosiloxane as in Example 1 were added to this hot mixture over the course of 5 minutes. After stirring at 6 m/s for a further 10 minutes, 50.00 parts of the 0.5% strength polyacrylamide solution as in Example 1 were added with cooling. This was followed by the addition of 10.00 parts of water. The whole was stirred until a temperature of <30° C. was reached, but for at least 10 minutes. Thereafter, the mixture was pumped at 50 bar through a gap homogenizer. An emulsion was formed which showed no deposition in either neat or diluted form.

### Comparative Example 2

5.00 parts of a mixture of equal parts of ethoxylated triglyceride as in Example 1 and ethoxylated fatty acid as in Example 1 were added to 10.00 parts of water at 60° C. and the mixture was stirred for 10 minutes with a turbine at a peripheral speed of 6 m/s. 16.00 parts of the SiO₂-containing organosiloxane as in Example 1 and 4.00 parts of the polyalkylene glycol ether as in Example 2 were added to this hot mixture. After stirring at 6 m/s for a further 10 minutes, 32.00 parts of the 0.5% strength polyacrylamide solution as in Example 1 and 30.00 parts of a 4.5% strength mixture of a linear, water-dispersible polyurethane as in Example 2 were added with cooling. The whole was stirred until a temperature of <30° C. was reached, but for at least 10 minutes. Thereafter, the mixture was pumped at 50 bar through a gap homogenizer. An emulsion was formed which showed no deposition in either neat or diluted form.

### Comparative Example 3

5.00 parts of a mixture of equal parts of ethoxylated triglyceride as in Example 1 and ethoxylated fatty acid as in Example 1 were added to 10.00 parts of water at 60° C. and the mixture was stirred for 10 minutes with a turbine at a peripheral speed of 6 m/s. 20 parts of the SiO₂-containing organosiloxane as in Example 3 were added to this hot mixture over the course of 5 minutes. After stirring at 6 m/s for a further 10 minutes, 50.00 parts of the 0.5% strength polyacrylamide solution as in Example 1 were added with cooling. This was followed by the addition of 10.00 parts of water. The whole was stirred until a temperature of <30° C. was reached, but for at least 10 minutes. Thereafter, the mixture was pumped at 50 bar through a gap homogenizer. An emulsion was formed which showed no deposition in either neat or diluted form.

### Comparative Example 4

3.00 parts of a mixture of equal parts of ethoxylated triglyceride as in Example 1 and ethoxylated fatty acid as in Example 1 were added to 10.00 parts of water at 60° C. and the mixture was stirred for 10 minutes with a turbine at a peripheral speed of 6 m/s. 20 parts of the SiO₂-containing organosiloxane as in Example 2 were added to this hot mixture over the course of 5 minutes. After stirring at 6 m/s for a further 10 minutes, 50.00 parts of the 0.5% strength polyacrylamide solution as in Example 1 were added with cooling. This was followed by the addition of 10.00 parts of water. The whole was stirred until a temperature of <30° C. was reached, but for at least 10 minutes. Thereafter, the mixture was pumped at 50 bar through a gap homogenizer. An emulsion was formed which in neat form showed slight deposition of active substance and in diluted form showed considerable deposition of active substance.

The particle distributions of Examples 1 to 4 and Comparative Examples 1 to 4 were measured using a Coulter LS 230.

| | Average particle | | |
|---|---|---|---|
| | size | Particle size range | |
| | [μm] | [μm] | Distribution form |
| Example 1 | 2.7 | 0.2 to 10 | Monomodal |
| Example 2 | 1.4 | 0.3 to 10 | Monomodal |
| Example 3 | 0.8 | 0.2 to 3 | Monomodal |
| Example 4 | 0.8 | 0.2 to 3 | Monomodal |
| Comp. 1 | 2.6 | 0.1 to 40 | Bimodal |
| Comp. 2 | 1.6 | 0.1 to 35 | Bimodal |
| Comp. 3 | 1 | 0.1 to 20 | Monomodal |

Owing to the instability of the product, it was not possible to determine the particle sizes of the comparative emulsion 4.

The defoamer emulsions for preparation in accordance with the invention had the following improved performance properties in particular:

Higher Dilution Stability

Using a balance, 5 g of defoamer emulsion were weighed out into a 250 ml glass beaker.

The emulsion was then rapidly dispersed with the addition of 45 ml of deionized water by swirling the glass beaker until dispersion was complete.

Assessment was made immediately following dilution, in accordance with the following rating scale:

| Rating: | Surface assessment of the dispersion: |
|---|---|
| 1 | no deposition |
| 2 | very thin oil film (Newton rings) |
| 3 | thin oil film |
| 4 | small oil drops and thin oil film |
| 5 | oil drops and deposition |
| 6 | large oil drops and severe deposition |
| Product | Rating of the dilution |
| Example 1 | 1 |
| Example 2 | 1 |
| Example 3 | 1 |
| Example 4 | 1 |
| Comp. 1 | 2 |
| Comp. 2 | 2 |
| Comp. 3 | 3 |
| Comp. 4 | 6 |

Greater Stability to External Shearing and to Impact and Collision

A 100 ml powder flask was filled to 80% with the emulsion for analysis, screwed shut and shaken on a shaking machine with a deflection of 30 mm and a frequency of 300 min⁻¹. The emulsions were examined visually each hour for their stability. The test was terminated after a maximum of 8 h.

| | Time after which deterioration of | Dilution after shaking |
|---|---|---|
| Product | the sample is observed | Rating |
| Example 1 | >8 hours | 1 |
| Example 2 | >8 hours | 2 |
| Example 3 | >8 hours | 2 |
| Example 4 | >8 hours | 2 |
| Comp. 1 | 1 hour | 6 |
| Comp. 2 | 4 hours | 5 |
| Comp. 3 | 3 hours | 6 |
| Comp. 4 | — | — |

Greater Heat/Low-Temperature Stability

The emulsions prepared in Examples 1 to 4 and Comparative Examples 1 to 3 were tested in terms of their freezing stability by freezing the emulsions at −15° C. and then thawing them at room temperature. This freezing was conducted 3 times in succession. The emulsions were subsequently diluted with deionized water and then rated.

For the determination of the heat stability, the emulsions were stored at 50° C. for 2 weeks. After cooling, the samples were diluted with deionized water and then assessed.

| | Dilution after | Dilution after hot |
|---|---|---|
| | 3 freeze/thaw cycles | storage |
| | Rating | Rating |
| Example 1 | 2 | 1 |
| Example 2 | 2 | 2 |
| Example 3 | 2 | 2 |
| Example 4 | 2 | 1 |
| Comp. 1 | 4 | 4 |
| Comp. 2 | 6 | 4 |
| Comp. 3 | 5 | 5 |

Lower Emulsifier Requirement

The stability comparison of emulsion 4 and of comparative emulsion 4 alone showed clearly that in accordance with the process of the invention the preparation of this emulsion was indeed possible with a lower emulsifier requirement, with markedly improved stability properties.

Higher Stability and Activity in Surfactant Concentrates

To examine the stability in surfactant concentrates, 1% of defoamer emulsion was added to the surfactant concentrate Marlosol® 013/50 (Hüls AG). This mixture was then diluted to 1% with deionized water and examined in a gassing test. In the gassing test, 1 liter of dilution was gassed with 6 liters of air per minute in a graduated 2 liter measuring cylinder using a frit of porosity D 1. A measurement was made of the time taken for 1 liter of foam to form. In order to determine the loss of activity occurring as a result of storage of the surfactant/defoamer mixture, the test was repeated following storage for 4 weeks.

| | Gassing test of the unstored | Gassing test after |
|---|---|---|
| | sample | 4 weeks of storage |
| | Time until 1 liter of foam | Time until 1 liter of foam |
| | [s] | [s] |
| No additive | 12 | 12 |
| Example 1 | 1970 | 1820 |
| Example 2 | 2740 | 2480 |
| Example 3 | 1750 | 1760 |
| Example 4 | 1790 | 1690 |
| Comp. 1 | 1610 | 65 |
| Comp. 2 | 2160 | 670 |
| Comp. 3 | 1440 | 185 |

Reduced Fault Susceptibility in Aqueous Overprint Varnishes

To examine the performance properties, a printing varnish was formulated in accordance with the following recipe, the amounts being % by weight.

| | | |
|---|---|---|
| Joncryl ® 74 | 50.5 | acrylate dispersion/Johnson |
| | | Polymer |
| Joncryl ® 680 | 23.1 | |
| Solution* | | |
| Jonwax ® 35 | 7.2 | polyethylene wax emulsion/ |
| | | Johnson Polymer |
| Water, demineralized | 12.4 | |
| Isopropanol | 2.9 | |
| Zn solution | 2.9 | |
| Defoamer emulsion | 1.0 | |
| | 100.0 | |
| *Joncryl ® 680 | 45.0 | acrylate resin/Johnson Polymer |
| 25% ammonia | 11.2 | |
| Isopropanol | 10.0 | |
| Water, demineralised | 33.8 | |
| | 100.0 | |

The last recipe constituent added was the defoamer emulsion, incorporation taking place by means of a bead mill disk at 1500 rpm for 3 minutes.

Foam Test

50 g of the aqueous printing varnish were weighed out into a 150 ml glass beaker and subjected to shearing with a dissolver disk (3 cm in diameter) at 2500 rpm for 1 minute. Subsequently, 45 g were weighed out into a measuring cylinder and the foam height was reported in ml.

Wetting Behavior

The aqueous printing varnish was knife-coated using a spiralwound coating bar (12 μm) wet onto transparent PVC film. The dried film thus applied was examined visually for wetting defects. The assessment was made in accordance with a scale from 1 to 4, 1 describing a defect-free film, 4 testifying to severe wetting defects.

Results

| | | |
|---|---|---|
| Example 1 | 48 ml/45 g | Rating 1 |
| Comparative Example 5 | 50 ml/45 g | Rating 3 |

Better (long-term) Defoaming in All-Acrylate and Acrylate Copolymer Dispersions and Coating Systems Based on These Dispersions

To examine further performance properties, the following emulsion paint recipe was selected (amounts in % by weight):

Emulsion paint:

| | | |
|---|---|---|
| Water | 36.2 | |
| Coatex ® P50 | 0.4 | Coatex, dispersant |
| Dispers 715 W | 0.1 | Tego, dispersant |
| Mergal ® K7 | 0.2 | Preservative |
| Coatex ® BR100 | 2.3 | Coatex, PU thickener |
| Calcidar ® extra | 22.1 | Omya, filler |
| Titanium dioxide | 17.5 | |
| Finntalk ® M15 | 4.7 | |
| NaOH, 10% strength | 0.1 | |
| Acronal ® 290D | 16.2 | BASF, styrene acrylate dispersion |
| Defoamer | 0.2 | |

All recipe constituents were used in as-supplied form. The last recipe constituent added in each case was the corresponding defoamer emulsion. Incorporation was carried out at 1000 rpm for one minute.

The activity was examined on the basis of the roller test, which is described below.

Roller Test

The so-called roller test came relatively close to the conditions encountered in practice, thereby permitting good differentiation between the different defoamer formulations also in respect of the concentrations to be used.

In the roller test, 40 g of the test emulsion paint were spread using an open-pored foam roller onto a nonabsorbent test card having a total surface area of 500 cm². Prior to the application of the paint, the foam roller was wetted with water. It was ensured that the additional amount of water introduced into the applied paint was always the same, so that the drying time of the paint always remained the same. The wet film add-on was approximately 300 g/m² surface area. After 24-hour drying of the film, the test panels were evaluated in respect of the macrofoam present (number of bubbles per 100 cm²), in terms of the microfoam present (number of pinholes by comparison with test panels with differing defect patterns, scale from 1 (very good) to 5 (deficient, many pinholes), and for any wetting defects.

These tests were repeated with the emulsion paint to which the additive had been added and which had been stored at 50° C. for 6 weeks.

Results of the Roller Test in Emulsion Paint

| Formu- | Concen- | Macrofoam | | Microfoam | | Wetting defects | |
|---|---|---|---|---|---|---|---|
| lation | tration | 0 w | 6 w | 0 w | 6 w | 0 w | 6 w |
| Blank | 0 | 50 | 50 | 4 | 4 | none | none |
| sample | | | | | | | |
| Ex.1 | 0.2 | 0 | 0 | 1 | 1 | none | none |
| Ex.1 | 0.1 | 0 | 1 | 1 | 1 | none | none |
| Ex.1 | 0.06 | 0 | 2 | 1 | 1 | none | none |
| Comp. 1 | 0.2 | 0 | 3 | 1 | 2 | none | none |
| Comp. 1 | 0.1 | 1 | 36 | 1 | 2 | none | slight |
| Ex.2 | 0.1 | 0 | 0 | 1 | 1 | none | none |
| Comp. 2 | 0.1 | 1 | 40 | 1 | 3 | none | severe |

The superiority of the defoamers prepared by the process of the invention in respect of their efficiency and in particular in respect of their long-term activity was evident.

As is also evident from the above performance examples, the defoamer emulsions prepared by the process of the invention feature improved product stabilities such as improved shaking stability and heat stability, without which they would in many cases not be able to be transported or subsequently used. Owing to the fundamentally better stabilization of these macroemulsions, there is also an improved dilution stability in all cases. It is also possible to prepare certain emulsions with a reduced emulsifier requirement, which at least restricts the use of these surfactants, which for the most part are ecotoxicologically objectionable. In particular, however, properties showing consistently marked improvement are obtained in application-relevant test systems.

The above description of the invention is intended to be illustrative and not limiting. Various changes or modifications in the embodiment described herein may occur to those skilled in the art. These can be made without departing from the scope and spirit of the invention.

What is claimed is:

1. A process for preparing a polyorganosiloxane emulsion, which comprises
a) formulating a mixture from:
from about 5 to about 50% by weight of polyorganosiloxanes optionally comprising hydrophobic solid bodies,
from 0 to about 20% by weight of organic oil,
from about 0.5 to about 10% by weight of one or more nonionic or anionic emulsifiers,
from 40 to 95% by weight of water, and
optionally, thickeners, protective colloids and/or auxiliary preservatives;
b) passing this mixture through, and dispersing it in, at least one interaction chamber having microchannels having a capillary thickness of from about 100 to about 500 μm in a pressure range from about 100 to about 1000 bar; and
c) releasing this mixture in an outlet reservoir,
wherein, the average droplet sizes being from about 0.5 to about 100 Mm.

2. The process as claimed in claim 1, wherein dispersion is carried out using two interaction chambers connected in series.

3. The process as claimed in claim 1, wherein the pressure range is from about 100 to about 600 bar.

4. The process as claimed in claim 1, wherein the pressure range is from about 150 to about 450 bar.

5. The process as claimed in claim 1, wherein the average particle size is from about 1 to about 20 μm.

6. The process as claimed in claim 1, wherein microchannels having a capillary thickness of from about 200 to about 400 μm are used.

7. The process as claimed in claim 1, wherein microchannels have a deflection angle.

8. The process according to claim 1, wherein
the emulsifiers are fatty acid esters of polyhydric alcohols, their polyalkylene glycol derivatives, the polyglycol derivatives of fatty acids and fatty alcohols, alkylphenol ethoxylates, block copolymers of ethylene oxide and propylene oxide, ethoxylated amines, amine oxides, acety lenediol surfactants, silicone surfactants, dialkylsulfosuccinates, alkyl ether sulfates and alkyl ether phosphates, alkyl sulfates and alpha-olefinsulfonates
the protective colloids and thickeners are methylcellulose, carboxymethyl cellulose, hydroxyethylcellulose, hydroxypropylcellulose, polyvinyl alcohol, poly acrylates and maleic anhydride copolymers, linear and branched polyurethanes, polyureas, polyetherpolyols, and xanthan gum,
the solid bodies are inorganic solids are unhydrophobicized or hydrophobicized silica, alumina, alkaline earth metal carbonates, alkaline earth metal salts of long-chain fatty acids of 12 to 22 carbon atoms, the amides of these fatty acids, and polyureas.

9. The process according to claim 1, which comprises
a) formulating a mixture
from 5 to 50% by weight of polyorganosiloxanes optionally comprising hydrophobic solid bodies,
from 0 to 20% by weight of organic oil,
from about 0.5 to 10% by weight of one or more nonionic or anionic emulsifiers,
from 40 to 95% by weight of water, and
optionally, thickeners, protective colloids and/or auxiliary preservatives;
b) passing this mixture through, and dispersing it in, at least one interaction chamber having microchannels having a capillary thickness of from 100 to 500 μm in a pressure range from 100 to 1000 bar; and
c) releasing this mixture in an outlet reservoir, wherein, the average droplet sizes being from 0.5 to 100 μm.

10. A polyorganosiloxane emulsion obtainable by a process as claimed in claim 1.

11. The polyorganosiloxane emulsion as claimed in claim 10, wherein polyorganosiloxanes comprise polyethersiloxane copolymers.

12. A polyorganosiloxane emulsion obtainable by the process according to claim 8.

13. A polyorganosiloxane emulsion obtainable by the process according to claim 9.

14. The polyorganosiloxane emulsion as claimed in claim 13, wherein the polyorganopolysiloxanes comprises polyethersiloxane copolymers.

15. A defoaming agent which comprises the organopolysiloxane emulsion as claimed in claim 10.

16. A defoaming agent which comprises the organopolysiloxane emulsion as claimed in claim 12.

17. The defoaming agent as claimed in claim 15, which comprises polymeric emulsifiers having an average molecular mass of more than 1000 daltons.

18. A release agent which comprises the organopolysiloxane emulsion claimed in claim 10.

19. A preservative for architecture which comprises an organopolysiloxane emulsion as claimed in claim 10.

20. A printing ink or varnish which comprises the defoaming agent as claimed in claim 15.

21. A paint which comprises the defoaming agent as claimed in claim 15.

22. A coating material which comprises an all acrylate dispersion and a defoaming agent as claimed in claim 15.

23. An adhesive which comprises a defoaming agent as claimed in claim 15.

24. A method for increasing the stability of an emulsion which comprises adding a defoaming agent as claimed in claim 15 to the emulsion.
